(19) United States
(12) Patent Application Publication
(10) Pub. No.: US 2008/0302750 A1
(43) Pub. Date: Dec. 11, 2008

(54) Self-orienting anti-two block switch assembly

(75) Inventor: Simon K. Worboys, Santa Ana, CA (US)

Correspondence Address: LADAS & PARRY LLP, 26 WEST 61ST STREET, NEW YORK, NY, 10023, US

(73) Assignee: DELAWARE CAPITAL FORMATION, INC.

(21) Appl. No.: 12/157,349

(22) Filed: Jun. 10, 2008

Related U.S. Application Data
(60) Provisional application No. 60/934,125, filed on Jun. 11, 2007.

(51) Int. Cl. B66C 13/18

(52) U.S. Cl. 212/281

(57) ABSTRACT

An anti-two block switch assembly for a crane is disclosed for preventing the crane from a two-blocking condition. The switch assembly includes a rotatable joint which allows the assembly to rotate about more than one axis. The switch assembly is also provided with a mounting plate and a mounting rod for mounting the switch assembly to the crane.

### CROSS REFERENCE TO RELATED APPLICATION(S)

This application claims the benefit of U.S. Provisional Application No. 60/934,125, filed Jun. 11, 2007, and incorporates the same by reference.

### FIELD OF THE INVENTION

The invention relates to an operational aid for cranes.

Particularly, the invention relates to an improved anti-two block switch assembly that includes a rotatable joint which allows the assembly to permit a rotational movement about more than one axis.

### BACKGROUND AND PRIOR ART

Cranes are well known as a lifting apparatus to raise, shift, and lower heavy objects or loads. A crane typically includes a boom, which may be telescopic, rotatably mounted on a base and a hoisting apparatus including a cable which is extended around upper load block (e.g. a sheave assembly) attached at the outer end of the boom (boom head) and connected to a lower load block (e.g. a sheave assembly) to a load attachment device (e.g. a hook). During operation of a crane, particularly, when the hoisting up a load, when the boom telescopes outwards and/or the boom is lowered, the lower load block may come into contact with the upper load block, the boom head, or other components attached thereon. This condition, which is known as “two-blocking”, could cause the cable to snap or break, and the load to drop, thereby resulting in costly damage to the crane, the load, and a dangerous situation for anyone nearby.

Therefore, operational aids, which are known as “anti-two block switches”, adapted for installation on booms to prevent two-blocking have been used. A typical anti-two block switch is attached near the upper load block or the boom head at one end, and attached to a weight through a cable or chain linkage at the other end. The weight normally maintains the switch in a position which enables to crane to operate. As the lower load block comes into contact with the weight, the tension in the cable relaxes, thereby moving the switch to a position to deactivate certain crane functions and prevent the two-blocking condition.

As discussed above, an anti-two block switch is typically attached near the upper load block or the boom head. Over the course of operation, it may be necessary to change the lower load block to accommodate various loads. Accordingly, it is desirable to provide a switch which is modular and which may be readily attached and detached.

Additionally, as the boom is raised or lowered, the angle between the switch on the upper load block (or the boom head) and the weight (and the load) changes. Since the operation of the switch requires that the weight maintain the switch in the working position (i.e. a misalignment may undesirably result in the switch being in the wrong position), proper alignment of the switch and the weight/load is required. Therefore, as the boom is raised or lowered, the switch must be able to permit a rotational movement of at least 90 degrees about a horizontal axis to ensure proper operation of the switch over the entire operating range of the boom.

Moreover, the switch may be preferably attached to the side of the upper load block or the boom head. Consequently, the switch must be maintain an angle that is off vertical even as the boom is raised or lowered in order to maintain alignment with the weight and the load. The angle can also vary depending upon the configuration of the upper load block.

One example of a known anti-two block switch is disclosed in U.S. Pat. No. 6,068,145, issued on May 30, 2000, to Stephen Luke.

### SUMMARY OF THE INVENTION

The invention provides an anti-two block switch assembly for a crane which can be detachably mounted on a crane.

The invention also permits an anti-two block switch assembly for a crane which permit a rotational movement about more than one axis

In a preferred embodiment, the invention provides an anti-two block switch assembly for a crane, the assembly including means for permitting a rotational movement of the assembly about all three axes.

In another preferred embodiment, the invention provides an anti-two block switch assembly for a crane, the assembly including a spherical (Heim) joint for mounting the assembly to a crane.

### BRIEF DESCRIPTION OF THE FIGURES OF THE DRAWING

FIG. 1 is a side elevational view showing a boom of a crane in a lowered position with a preferred embodiment of the invention.

FIG. 2 shows the boom of FIG. 1 in a raised position.

FIG. 3 is a front elevational view showing a boom of a crane with the preferred embodiment of the invention.

FIG. 4 is a front elevational view showing the preferred embodiment of the invention with a multi-sheave lower load block.

FIG. 5 is a side elevational view of the preferred embodiment of the invention in a non-working position.

FIG. 6 shows the preferred embodiment of the invention of FIG. 5 in a working position.

FIG. 7 is an exploded view showing the attachment assembly of the preferred embodiment of the invention.

### DETAILED DESCRIPTION

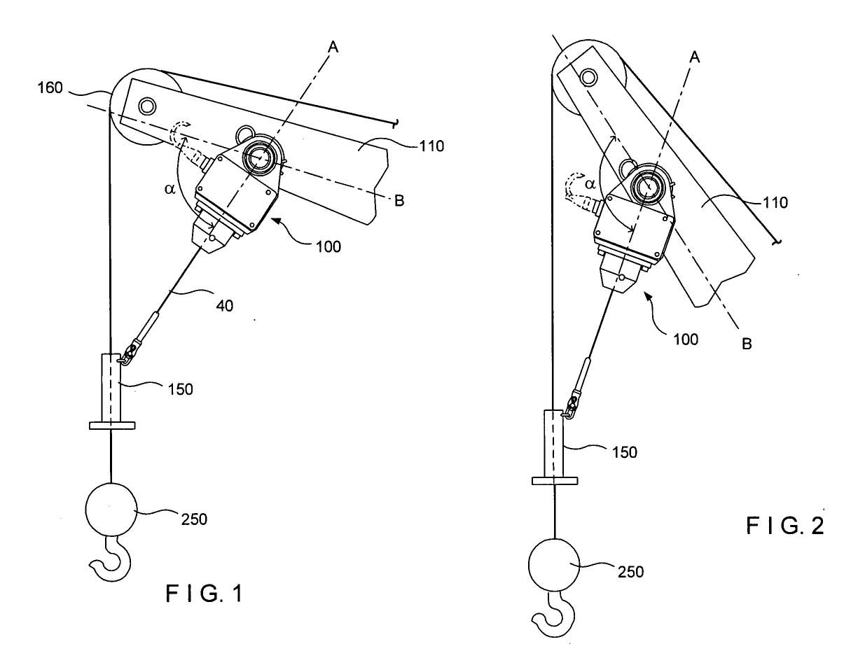

Referring to FIGS. 1-4, a cable of a hoisting apparatus is extended along a boom head 110 of a crane, over a sheave assembly 160, and connected to a load attachment device 250 (shown as a hook with a weighted ball top to keep the cable taut). An anti-two block switch assembly 100 in accordance with a preferred embodiment of the invention is mounted near the boom head 110 at one end, and connected to a weighted member 150 at the other end. The weighted member 150 forms a sleeve through which the cable passes.

As shown in FIG. 1, when the boom is in a lowered position, the connecting line 40, which defines axis A, and the boom head 110, which defines axis B, form an angle α therebetween. As the boom is raised to a raised position shown in FIG. 2, the angle α increases. Therefore, the switch assembly 100 desirably needs to permit a rotational movement about a first axis which is normal to axes A and B in order to ensure the proper alignment between the switch assembly 100 and the weighted member 150 so that the connecting line 40 remains taut and maintains the switch assembly 100 in the working position as the boom raises or lowers.

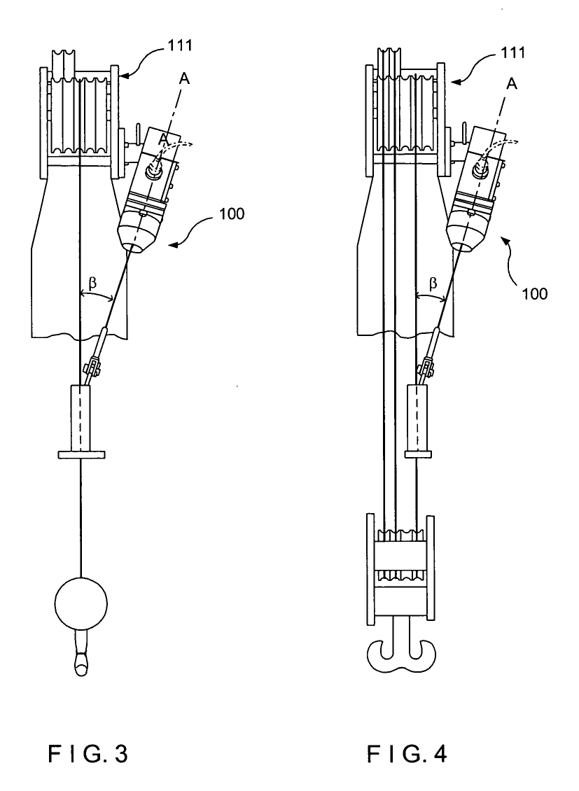

As shown in FIG. 3, the portion of the cable extending over the sheave 160 and connected to the load attachment device 250 forms a vertical axis. As the switch assembly 100 is connected to the side of the boom head 111, the axis A defined by the connecting line forms an angle p with the vertical axis formed by the cable. Therefore, the switch assembly 100 desirably needs to be able to maintain the proper angle β even as the boom raises or lowers.

FIG. 4 shows the switch assembly 100 mounted on an upper load block 111 which operates with a lower load block connected to the load attachment device. The upper load block 111 and the lower load block both have a plurality of sheaves rotating about respective horizontal axes. The cable is wounded over the sheaves forming multiple segments therebetween, and depending on which segment the cable the weighted member 150 passes, the angle β may be greater or less than that shown in the figuration of FIG. 3.

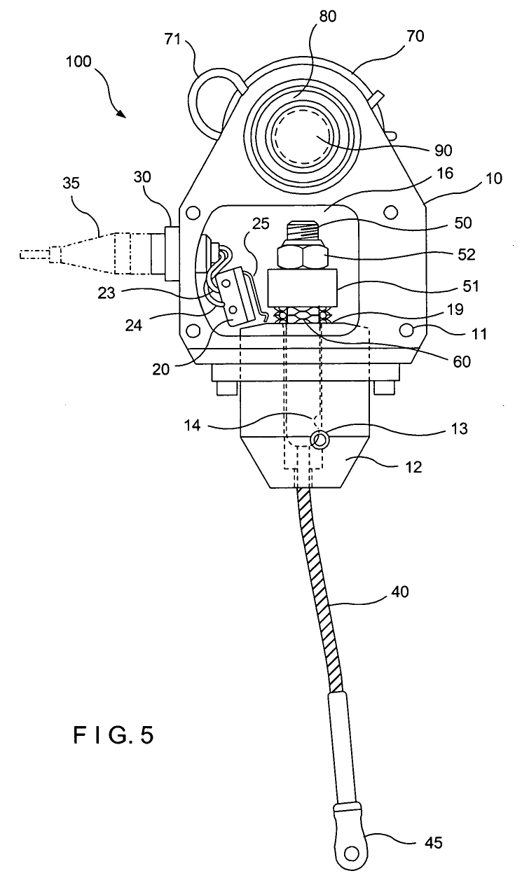

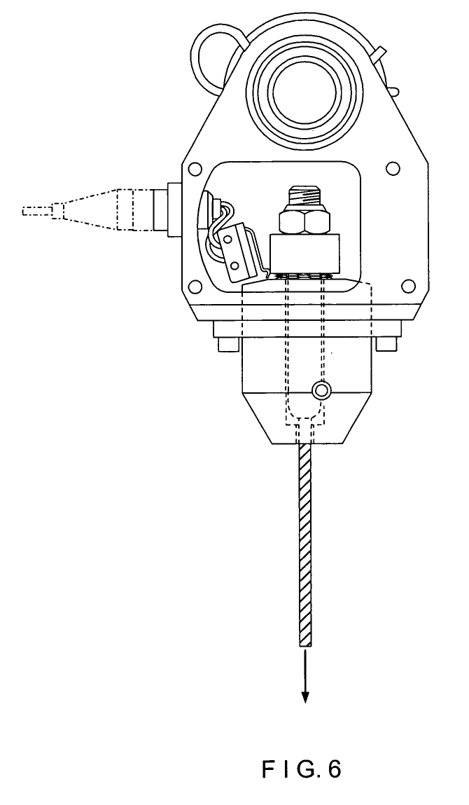

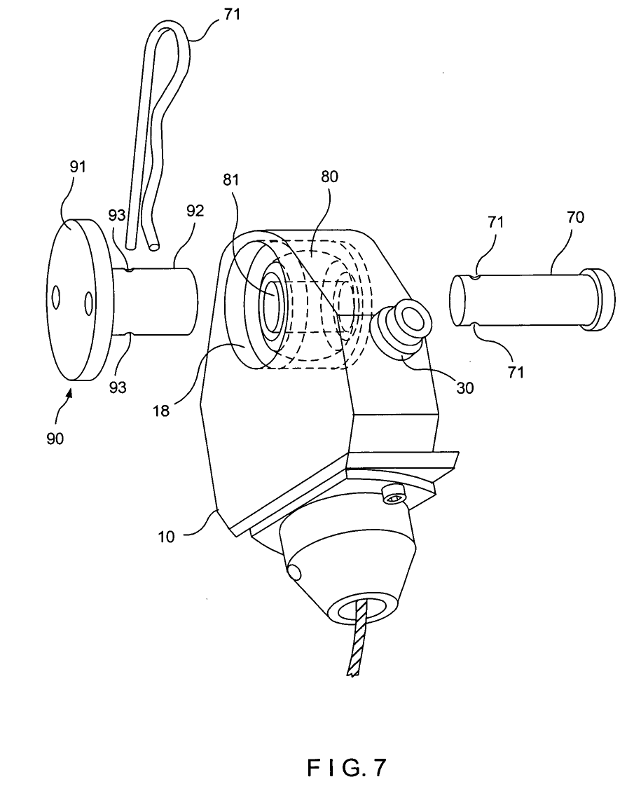

With reference to FIG. 5, parts of the switch assembly 100 in accordance with a preferred embodiment of the invention will now be discussed.

The switch assembly 100 includes a housing 10 having a main compartment 16 which may be sealed by a cover (not shown in this figure). Screw holes 11 are provided to screw the cover onto the switch assembly 100.

Inside the compartment, there is provided a switch 20 (e.g. an electrical switch) having an arm 25, which may be moved to open or close a circuit, thereby controlling the crane. The switch is connected to a connector portion 30, which is connectable to a connector 35, via wires 23 and 24 to send a electrical signal to control the crane. The compartment 16 is also provided with a control assembly which extends to a lower end 12 of the housing 10. The control assembly includes a plunger 50 having a threaded top, a spring coiled over the plunger, a control portion 51 on top of the spring coil 60, and a nut threadably engaging the plunger 50 to keep the control portion 51 at a fixed position relative to the plunger 50. The cable 40 is fixed at the upper end to the plunger 50 and extends through a center channel of the plunger and an opening of the lower end 12 of the housing 10. The cable 40 has a weighted member connector 45 to connect to the weighted member 150.

As shown in FIG. 5, when there is a slack in the cable 40, the spring 60 urges the plunger upwardly against a lower surface 19 of the compartment 16, thereby moving the control portion 51 upwardly away from the arm 25 of the switch 20. This maintains the switch assembly 100 in a non-working position in which the switch 20 is in an open-circuit condition, and the crane does not operate. The switch assembly 100 may enter this position when no weighted member is connected or when the weighted member 150 is moved upwardly by the load attachment device 250 toward the switch assembly 100 (past a desired position).

When the weighted member 150 is connected to the switch assembly 100 during normal operation, the weighted member creates a downward force which pulls the plunger downwardly, thereby overcoming the upward force of the spring 60. This moves the control portion 51 into contact with the arm 25 of the switch 20 and pushing the arm 25 toward the switch thereby activating the crane. The plunger 50 may be provided with a recessed portion 14 arranged such that a locking pin may be inserted through an opening 13 on the lower portion 12 of the housing 10 to lock the plunger (and the switch assembly) in the working position.

Referring now to FIG. 7, the top end of the housing 10 is provided with a spherical joint (Heim joint) which allows multiple degrees of freedom of motion thereby enabling self-alignment of the switch assembly 100. The spherical joint includes a circular casing enclosing a ball swivel 80. The ball swivel 80 permits a rotational movement about all three axes inside the casing. In a preferred embodiment, the spherical joint allows a 360 degree of freedom about a horizontal axis and 15 degrees of freedom in all other directions.

A mounting plate 90, a mounting rod (Clevis pin) 70, and an R-clip (often referred to as a hair clip) 71, are provided to secure the switch assembly 100 to an upper load block or boom head of a crane. Specifically, the mounting plate 90 has a bottom portion having a mounting surface 91 for mounting onto a surface of the upper load block or the boom head. The mounting plate 90 is also provided with a stem portion 92 having a central opening for receiving the mounting rod 70. The mounting rod 70 has a widened head which abuts against a side of the ball swivel, and extends through the opening of the ball swivel into the stem 92 of the mounting plate 90. Once the holes 71 of the mounting rod 70 and the holes 93 of the mounting plate 93 are aligned, an R-clip 71 passes through the holes 71 and 93 thereby securing the switch assembly 100 on the upper load block or the boom head. To detach the switch assembly 100, one simply removes the R-clip 71 and the mounting rod 70.

Furthermore, although the invention is disclosed with reference to particular embodiments thereof, it will become apparent to those skilled in the art that numerous modifications and variations can be made which will fall within the scope and spirit of the invention as defined by the attached claims. For example, although a spherical (Heim) joint is disclosed, other configurations may be utilized to provide multiple degrees of freedom of motion of the switch assembly. Additionally, the working and non-working positions of the switch may be reversed.

I claim:

1. In an anti-two block switch assembly for a crane comprising switch for deactivating the crane when approaching a two block condition, the improvement comprising:
a rotatable mounting for rotatably mounting the switch assembly to the crane to permit a rotational movement about more than one axis.

2. An anti-two block switch assembly according to claim 1, wherein the rotational movement is about all three axes.

3. An anti-two block switch assembly according to claim 1, wherein the rotatable mounting comprises a spherical joint.

4. An anti-two block switch assembly according to claim 3, wherein the spherical joint allows a 360 degree of freedom about a horizontal axis and 15 degrees of freedom in other directions.

5. An anti-two block switch assembly according to claim 3, wherein the spherical joint comprises a ball swivel having an opening,
the rotatable mounting further comprises
a mounting plate for mounting the switch assembly onto a surface of the crane, the mounting plate having an opening,
a mounting rod extending through the openings of the ball swivel and the mounting plate, and
a fastener for securing the mounting plate to the mounting rod.

6. An anti-two block switch assembly according to claim 5, wherein the fastener is an R-clip.

7. An anti-two block switch assembly for a crane comprising:
a housing;
switch inside the housing for deactivating the crane;
a control for controlling the switch; the control being movable to contact the switch;
a rotatable mounting for rotatably mounting the switch assembly to the crane to permit a rotational movement about more than one axis;
a weighted member including contacting means for contacting a traveling member of the crane, the weighted member being connected to the control; and
a spring urging the control away from the switch to deactivate the crane when the traveling member moves upwardly beyond a desired level.

8. An anti-two block switch assembly according to claim 7, wherein the rotational movement is about all three axes.

9. An anti-two block switch assembly according to claim 7, wherein the rotatable mounting comprises a spherical joint.

10. An anti-two block switch assembly according to claim 9, wherein the spherical joint comprises a ball swivel having an opening,
the rotatable mounting further comprises
a mounting plate for mounting the switch assembly onto a surface the crane, the mounting plate having an opening,
a mounting rod extending through the openings of the ball swivel and the mounting plate, and
a fastener for securing the mounting plate to the mounting rod.

11. An anti-two block switch assembly according to claim 10, wherein the fastener is an R-clip.

12. An anti-two block switch assembly according to claim 9, wherein the spherical joint allows a 360 degree of freedom about a horizontal axis and 15 degrees of freedom in other directions.

13. An anti-two block switch assembly according to claim 7, wherein the switch is an electrical switch.

14. An anti-two block switch assembly according to claim 13, wherein the electrical switch includes an arm, and wherein the control comprises
a plunger,
a contacting member for contacting the arm of the electrical switch,
wherein when the traveling member moves upwardly beyond a desired level, the spring urges the plunger upwardly to move the contacting member out of contact with the arm of the electrical switch thereby deactivating the crane.
